(19) United States
(12) Patent Application Publication
(10) Pub. No.: US 2017/0098196 A1
(43) Pub. Date: Apr. 6, 2017

(54) PREDICTING ACTUAL EVENT TIMES BASED ON COMPOSITE EXPERIENCE DATA

(71) Applicant: INTERNATIONAL BUSINESS MACHINES CORPORATION, Armonk, NY (US)

(72) Inventors: Darryl M. Adderly, Morrisville, NC (US); Christopher T. Boulton, Chapel Hill, NC (US); Bryan D. Cardillo, Cary, NC (US); Gerald L. Mitchell, JR., Durham, NC (US); Kevin L. Schultz, Raleigh, NC (US)

(21) Appl. No.: 14/876,314

(22) Filed: Oct. 6, 2015

(51) Int. Cl. G06Q 10/10; H04L 12/58

(52) U.S. Cl. CPC G06Q 10/1095; H04L 51/04

(57) ABSTRACT

Methods and systems for predicting a start time of an event include determining a previous start time for a recurring event based on data collected from individual attendees. A probable future start time for the event is estimated based on the previous start time using a processor. The probable future start time is published to one or more prospective attendees.

### BACKGROUND

Technical Field

The present invention relates to event scheduling and, more particularly, to inferring actual event times based on a variety of information sources.

Description of the Related Art

Social and business events are scheduled with specific start times, but these events are often controlled by factors outside the event planners' or attendees' control. For example, movie theaters show lengthy advertisements and previews before the show begins. However, movie goers have no information regarding the length of these segments and hence do not know when the movie actually begins. As a result, a movie goer who is not interested in previews or advertisements will be forced to sit through those segments to avoid the rick of missing part of the movie Similarly, a concert may feature a less popular opening band, and attendees have no way to know when the band they are actually interested will begin playing.

### SUMMARY

A method for predicting a start time of an event includes determining a previous start time for a recurring event based on data collected from individual attendees. A probable future start time for the event is estimated based on the previous start time using a processor. The probable future start time is published to one or more prospective attendees.

A method for predicting a start time of an event includes determining a previous start time for a recurring event based on data collected from individual attendees. A previous end time for the recurring event is determined based on data collected from individual attendees. A probable future start time for the event is estimated based on the previous start time, the previous end time, and a predetermined running time for the recurring event using a processor. The probable future start time is published to one or more prospective attendees.

A system for predicting a start time of an event includes a prediction module having a processor configured to determine a previous start time for a recurring event based on data collected from individual attendees and to estimate a probable future start time for the event based on the previous start time. A publishing module is configured to publish the probable future start time to one or more prospective attendees.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 is a block/flow diagram of a method for predicting an actual start time of an event in accordance with the present principles;

FIG. 2 is a timeline illustrating the progression of an exemplary event in accordance with the present principles;

FIG. 3 is a block diagram of a system for predicting an actual start time of an event in accordance with the present principles.

### DETAILED DESCRIPTION

Embodiments of the present invention use information from a variety of sources to predict an accurate start time for a scheduled event. Such sources may include scheduled times, venue information, mobile phone sensors, and user feedback. Using these information sources, an accurate prediction is generated that allows users to save valuable time by avoiding the unnecessary precursors to the event that they desire to attend. They can then arrive as close as possible to the actual start time. Businesses can take advantage of the information by, for example, selling tickets to users who might otherwise think they were too late for the event, or for selling additional concessions to users who would otherwise have rushed to the showing.

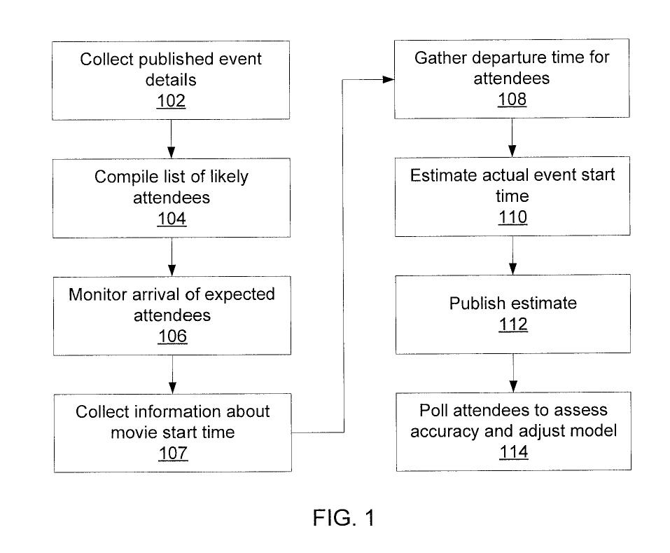

Referring now to the drawings in which like numerals represent the same or similar elements and initially to FIG. 1, block 102 collects published event details. This may include a list of known details that are scraped from a website or otherwise mined from public information sources. For example, a movie may have a published start time and duration. Other information may include venue information. For example, if a given movie theater has published times for a movie showing in a given room, a latest ending time for the show in question can be inferred based on the start time for the next showing—the room will need to be cleared and the next audience will be given time to enter, setting limits on how late the desired show can actually begin.

Block 104 collects a list of likely event attendees based on, for example, purchase data, search records, and location data. Block 106 monitors the expected attendees for their arrival at the event and block 108 monitors their departure. These two data collection steps may be performed until either all of the attendees are accounted for or the event is no longer of interest. Attendee arrival and departure times provide empirical feedback for the actual duration of the event and, particularly for events that have definite run times, gives feedback as to when the event actually began. Block 107 separately collects information that may be used to infer specific event start times. Using the collected information, block 110 estimates an actual start time for the event, which block 112 publishes for future events. The estimate may indicate a confidence level that may be a range of times or a percentage. Block 114 optionally polls users to assess the accuracy of the prediction and adjust the prediction model.

The monitoring of individual attendees in blocks 106 and 107 may be performed in any of a variety of ways, depending on the devices they have on their person. Their locations can be reported according to, e.g., global positioning satellite information, wireless network triangulation, and cell tower triangulation. Their environment can be sensed according to light levels, including ambient and forward light sensors or even with a device's camera. Their movements can be detected using a device's accelerometer, light information, or location information. Sound can be measured through a device's microphone, detecting for example the ambient sound level or detecting a known intro theme, and the volume level of the device can also be tracked to see if a user has muted it. Additional information regarding the user's state can be gleaned from data monitoring, determining which applications are active, whether the device is connected to a network, and any changes to the device's settings the user makes. Furthermore, the user's communications on social media, calendar entries, ticket purchases, and other expressions can be reviewed to determine the user's intent.

Block 110 uses this information to determine correlations across time, user location, and user intent to determine group behavior and determine what a group as a whole reacts to. For example, if a significant number of attendees silence their phones all at once, it can be deduced that a warning has just been played instructing an audience to that effect. The determination may include a number of different factors. For example, if a significant number of devices register a decrease in ambient light, an increase in ambient sound, devices being set to silent, and a location appropriate to the event, it may be determined that the event is about to begin, and this time may be logged.

Block 110 may perform similar correlations to determine the time for the end of the event, with an increase in ambient light, a decrease in ambient sound, and settings changes or application usage signal the end of the event. Block 110 may then use the end time in combination with a published or expected run time for the event to provide additional information regarding the actual starting time. Block 110 may then determine a most likely start time for the event at that particular venue. Some uncertainty may remain, and this uncertainty may be reflected in the estimated start time that is provided in block 112.

User feedback in block 114 may consider a variety of forms of feedback, including, for example, ratings, surveys, application input, and forum entries. Block 114 may then make adjustments in response to the feedback. In one example, a user might remark that, “venue includes security which restricts access five minutes after posted event starting time,” which would add an additional time constraint to the determinations of block 110.

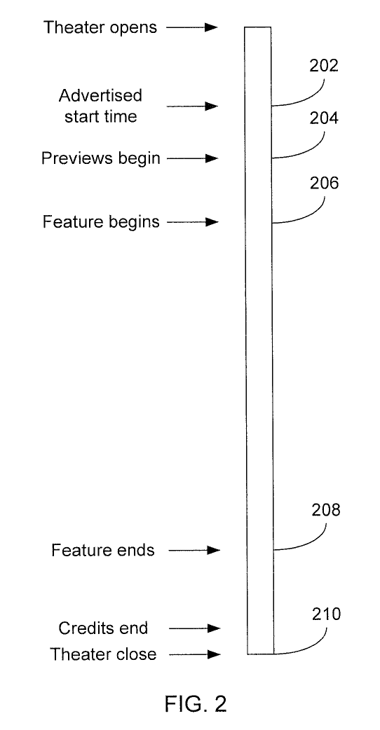

Referring now to FIG. 2, a timeline for an exemplary movie event is shown. The advertised start time at 202 is published data, but during this time other content will be showing, such as advertised and informational announcements. By the time the previews begin at 204, it is expected that the majority of attendees (e.g., 80%) will have arrived. The feature actually begins at 206, by which nearly all of the attendees should have arrived. The majority of the attendees will leave when the feature ends at 208, as the credits and any post-feature content is played. Finally, the credits end and the theater closes at 210, as the remaining attendees leave. The aim of the present embodiments is to accurately identify the time 206 at which the feature begins.

In one concrete example, consider predicting the start time of Movie A. Block 102 collects the published event starting time, which is advertised as beginning at 7:40 pm. Ten minutes prior to the advertised start time (7:30 pm), block 104 determines that 95% of the tickets have been sold. In a theater of 100 seats, it is therefore expected that 95 seats will be occupied. Block 106 uses, e.g., chair sensors, ticket bar code scanners, or other positioning information to determine that 80% of the patrons have arrived and are seated at 7:50 pm. Previews begin at this time, and patrons continue to arrive until 7:57 pm, at which 95% of the expected patrons have arrived. The movie begins to play at 8:02 pm, at which 99% of the expected patrons are seated. Block 107 also monitors lighting changes and cell phone state events to determine when the movie itself has begun.

The next show time for the movie is at 10:15 pm. The difference between the published and actual start times of the previous showing was twenty-two minutes (7:40 pm to 8:02 pm). Using this information, the initial prediction for the 10:15 pm movie is that it will actually begin at 10:37 pm. However, in this example, the night in question is in the opening weekend for Movie A, and the last showing of the night is sold out. Given that that show is filled to capacity, more late arrivals are expected (based on data from previous late shows), and so block 110 extends the actual start time to be 10:45 pm.

There is some uncertainty to these predictions. If the movie theater begins its starting time based on a percentage of attendees in the audience, then the theater may wait longer before it shows the previews (and hence the movie) if fewer people than expected have arrived at the predicted time. As such, block 112 may publish not only the estimated time of 10:45 pm, but also a plus-or-minus of three minutes to accommodate the possibility that people will be on time or late.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PTA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

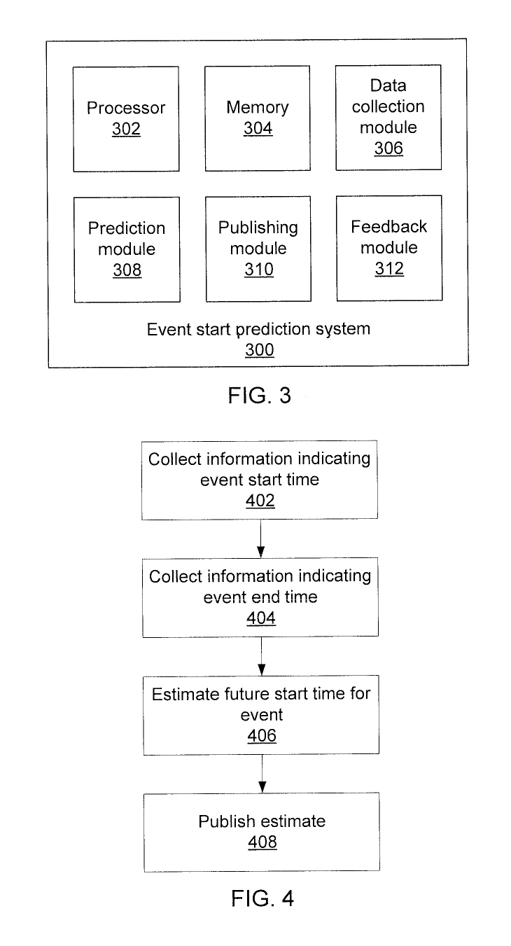

Referring now to FIG. 3, an event start prediction system 300 is shown. The system 300 includes a hardware processor 302 and a memory 304. It should be noted that various modules may be implemented as software, executed on the processor 302. Alternatively, such modules may be implemented as separate hardware modules implemented in the form of, e.g., an application specific integrated chip or a field programmable gate array. A data collection module 306 collects information about potential and actual attendees from a variety of sources including, for example, individual user devices and public sources, and stores the data in memory 304. A prediction module 308 uses the data assembled by the data collection module 306 to determine an estimate for the actual start time of an event. A publishing module 310 makes the estimated start time available to users, either through publication on a central site or through, for example, distributed user applications. A feedback module 312 obtains direct or indirect feedback from users regarding the event and its timing to further enhance the estimates made by prediction module 308.

Referring now to FIG. 4, a block/flow diagram of an overview of the present principles is provided. Block 402 collects information indicating the actual start time of an event. It should be noted that this event may be any type of event where the expected actual start time is different from the advertised start time. Block 404 collects information indicating the actual event end time. These types of information may include monitoring attendees and/or their personal devices as described above.

Block 406 estimates a future start time for the event. Using the collected information to set boundaries for when the last event actually started, block 406 determines estimates when a future iteration of the event will actually begin and optionally expresses it with an expected error. Block 408 then publishes the estimate with any computed error.

Having described preferred embodiments of predicting actual event times based on composite experience data (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method for predicting a start time of an event, comprising:
determining a previous start time for a recurring event based on data collected from individual attendees;
estimating a probable future start time for the event based on the previous start time using a processor; and
publishing the probable future start time to one or more prospective attendees.

2. The method of claim 1, further comprising determining a previous end time for the recurring event based on data collected from the individual attendees.

3. The method of claim 2, wherein estimating the probable future start time is further based on the previous end time.

4. The method of claim 3, wherein estimating the probable future start time comprises determining a difference between the previous end time and a predetermined running time for the recurring event.

5. The method of claim 1, further comprising collecting feedback from attendees, wherein estimating the probable future start time is further based on the feedback.

6. The method of claim 1, wherein the data collected comprises environmental conditions measured by devices in the possession of the individual attendees.

7. The method of claim 1, wherein the data collected comprises changes to one or more setting on devices in the possession of the individual attendees.

8. The method of claim 1, wherein the data collected comprises a published start time and duration of the event.

9. The method of claim 1, wherein the data collected comprises textual information generated by the individual users.

10. A computer readable storage medium comprising a computer readable program for predicting a start time of an event, wherein the computer readable program when executed on a computer causes the computer to perform the steps of claim 1.

11. A method for predicting a start time of an event, comprising:
determining a previous start time for a recurring event based on data collected from individual attendees;
determining a previous end time for the recurring event based on data collected from individual attendees;
estimating a probable future start time for the event based on the previous start time, the previous end time, and a predetermined running time for the recurring event using a processor; and
publishing the probable future start time to one or more prospective attendees.

12. A system for predicting a start time of an event, comprising:
a prediction module comprising a processor configured to determine a previous start time for a recurring event based on data collected from individual attendees and to estimate a probable future start time for the event based on the previous start time; and
a publishing module configured to publish the probable future start time to one or more prospective attendees.

13. The system of claim 12, wherein the prediction module is further configured to determine a previous end time for the recurring event based on data collected from the individual attendees.

14. The system of claim 13, wherein the prediction module is further configured to estimate the probable future start time based on the previous end time.

15. The system of claim 14, wherein the prediction module is further configured to determine a difference between the previous end time and a predetermined running time for the recurring event.

16. The system of claim 12, further comprising a feedback module configured to collect feedback from attendees, wherein the prediction module is further configured to estimate the probable future start time based on the feedback.

17. The system of claim 12, wherein the data collected comprises environmental conditions measured by devices in the possession of the individual attendees.

18. The system of claim 12, wherein the data collected comprises changes to one or more setting on devices in the possession of the individual attendees.

19. The system of claim 12, wherein the data collected comprises a published start time and duration of the event.

20. The system of claim 12, wherein the data collected comprises textual information generated by the individual users.
